(19) United States
(12) Patent Application Publication
(10) Pub. No.: US 2008/0146486 A1
(43) Pub. Date: Jun. 19, 2008

(54) Frabric treatment method and composition

(75) Inventors: Christopher Boardman, Bebington (GB); Kenneth Stuart Lee, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/983,933

(22) Filed: Nov. 13, 2007

(30) Foreign Application Priority Data
Nov. 17, 2006 (GB) 0623005.6

(51) Int. Cl. C11D 3/37

(52) U.S. Cl. 510/519

(57) ABSTRACT

A fabric softening composition comprising a fabric softening compound and a material having a thermal phase transition temperature in the range 26 to 39° C. encapsulated in a polymer shell (TPTT material) to provide encapsulated particles having a particle size in the ranges from 10 nm to 1000 μm, preferably from 50 nm to 100μ, more preferably 0.2 to 20 μm.

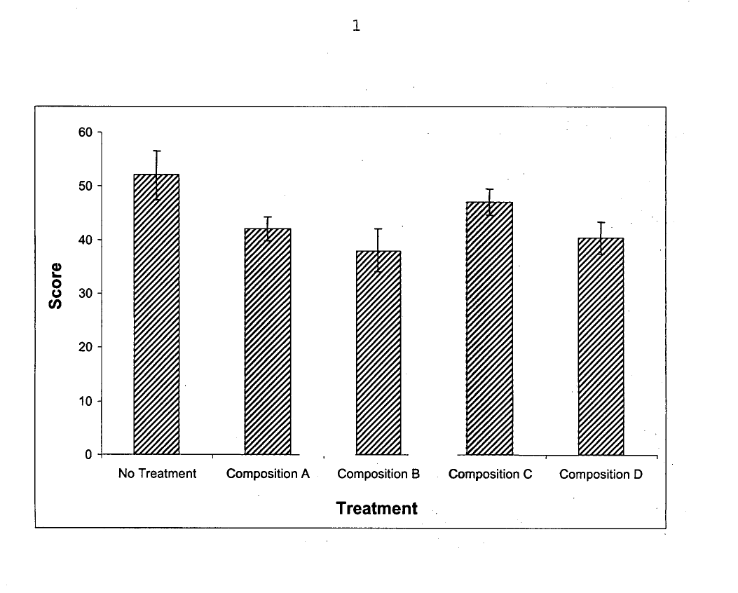

### TECHNICAL FIELD

The present invention relates to a method of treating a fabric with a rinse conditioner composition to impart a cool feel to the fabric and to compositions for use therein.

### BACKGROUND AND PRIOR ART

In order to cope with differences in the weather and season a wide variety of different garments and cloths have been designed. In addition, various attempts have been made to provide adaptable clothing and products which can reduce the effect of more immediate fluctuations in temperature or climate e.g. from warm inside to cold outside, from warm day time to cold night time etc.

For example, some functional fabrics employ phase change materials incorporated into the polymer melt prior to fibre extrusion before fabric construction and other fabrics have, attached thereto phase change materials incorporated into inorganic shells e.g. silica.

WO03/014460 discloses a composition having a phase transition material that provides a temperature control benefit. The composition is directly applied to a consumer-treatable surface, including a hard surface such as walls, floors, ceilings, a soft surface including clothes, shoes, gloves, socks, curtains and human or animal skin and dried.

Also, there is no messiness feeling when a phase change transition of the phase transition material occurs, preferably, also when the composition is directly applied to the consumer treatable surface. If the composition is in a liquid/gel form, it is dried before a phase transition occurs. The temperature control benefit can noticeably increase or decrease the temperature of the climate around the surface, so as to make the climate more comfortable.

It has now been found that it is possible to impart a cool feel to garments by applying a material having a thermal phase transition temperature in the range 26 to 39° C. to a garment from a fabric softening composition.

### SUMMARY OF THE INVENTION

According to one aspect of the general invention there is provided the use of a fabric softening composition comprising a fabric softening compound and a material having a thermal phase transition temperature in the range 26 to 39° C. to impart a cool feel to a fabric.

According to a further aspect of the invention there is provided a fabric composition comprising a fabric softening compound and a material having a thermal phase transition temperature in the range 26 to 39° C., in the form of encapsulated particles having a particle size in the range from 10 nm to 1000 μm, preferably 50 nm to 100 μm, more preferably 0.2 to 20 μm.

The use of a fabric softening composition provides a convenient mode of delivery for the material having a thermal phase transition temperature in the range 26 to 39° C. (hereinafter TPTT material). It is possible to deposit sufficient TPTT material such that after drying it provides a noticeable cool feel when the garment is initially touched or worn. The sensation is similar to the cool feel when a metal surface is touched. The cool feel of the garment provides a pleasant, refreshing sensation when the garment is first put on.

It is also possible to deposit sufficient TPTT material such that after drying it provides a garment with a degree of temperature regulation ‘climate control’. The addition of TPTT to garments, allows interaction with the skin's temperature to provide a buffer against temperature changes.

TPTT are materials that can absorb, store and release heat whilst the material changes its physical form. This is known as a phase change. Water changing from solid (ice) to liquid is an example of this phenomenon. During these phase changes large amounts of heat are absorbed or released.

### DETAILED DESCRIPTION OF THE INVENTION

### TPTT Material

The TPTT material has a thermal phase transition temperature in the range 26 to 39° C. The TPTT may conveniently be measured by the Perkin & Elmer thermal analysis system. The Perkin & Elmer thermal analysis system measures the heat flow into a material to be heated as a function of the temperature of the material. By investigating a material at various temperatures, a temperature profile is obtained. Such a temperature profile usually has one or more peaks, each peak corresponding to a maximum for the heat flow into the material at a specific temperature. The temperature corresponding to the major peak in the temperature profile is referred to as the thermal phase transition temperature. Generally a high TPTT corresponds to a high softening temperature of the material.

TPTT materials possess a latent heat and show a phase transition phenomena between phases at a phase transition temperature. The phase transition of the present invention incorporated solid to liquid, liquid to vapor, solid to vapor, gel to liquid-crystalline phase changes. In the present invention, preferable phase transition are solid to liquid phase or liquid to solid phase changes. At these phase changes, PTMs reversibly absorb or release heat from the environment at around the phase transition temperature, which is accompanied with a corresponding change in the ambient temperature.

The TPTT material may be in the form of a composition provided that the total composition has a TPTT in the range 26 to 39° C. Suitable compositions comprise hydrocarbon materials comprising a linear or branched alkyl chain and preferably comprising an average of from 12 to 50 carbon atoms per molecule, preferably from 12 to 30 carbon atoms. Preferably, the hydrocarbon materials are either alkanes or alkenes. Relatively small amounts of non-alkyl substituent groups may be present provided the hydrocarbon nature of the product is not substantially affected.

Examples of suitable hydrocarbon materials for use in the hydrocarbon composition are the liquid hydrocarbon materials of natural source. Other liquid hydrocarbon materials including the liquid fractions derived from crude oil, such as mineral oil or liquid paraffins and bracked hydrocarbons.

Examples of solid or semi-solid hydrocarbon materials are the paraffinic materials of longer chain length, and hydrogenated versions of some of the liquid materials mentioned above.

A particularly useful combination of hydrocarbon materials is a mixture of mineral oil (M85 ex Daltons Company) and petroleum jelly (Silkolene 910 ex Daltons), wherein the weight ratio of mineral oil to petroleum jelly is chosen such that the TPTT of the mixture is more than 27° C. and less than 38° C. In our experiments this result was obtained by using a ratio of mineral oil to petroleum jelly of less than 3:1, preferably from 2:1 to 1:3. Mineral oil is a liquid mixture of linear and branched hydrocarbons having an average number of carbon atoms per molecule of 26. Petroleum jelly is a semi-solid mixture of linear and branched hydrocarbons having an average number of carbon atoms per molecule of 26, and having a softening temperature of about 50° C.

In one embodiment of the invention the TPTT material is encapsulated in a polymer shell to form encapsulated particles having a particle size of from 10 nm to 1000 μm, preferably 50 nm to 100 μm, more preferably 0.2 to 20 μm. The use of encapsulated materials has the advantage that the materials may be readily dispersed without interference or interaction with the fabric softener compound. An additional advantage in that the encapsulated material does not cause a “messiness” feeling when deposited on the fabric which may be present with materials of a semi-liquid nature.

Suitable encapsulating polymers include those formed from melamine-formaldehyde or urea formaldehyde condensates, as well as similar types of aminoplasts. Additionally, capsules made via the simple or complex coacervation of gelatin are also preferred for use with the coating. Capsules having shell walls comprised of polyurethane, polyamide, polyolefin, polysaccaharide, protein, silicone, lipid, modified cellulose, gums, polyacrylate, polyphosphate, polystyrene, and polyesters or combinations of these materials are also functional.

Suitable TPTT materials are disclosed in WO 03/0144460 and EP0371535. A preferred material in Lurapret TX PMC 28 commercially available from BVASF which is a material encapsulated in polymethylmethacrylate having a particle size in the range 0.2 to 20 μm.

The TPTT materials are generally deposited to apply from 0.2 to 1%, preferably 0.2 to 0.5% by weight of the fabric after drying. The TPTT materials are generally present in an amount of from 5 to 50%, preferably 5 to 25% by weight of the fabric softening composition.

### Fabric Softening Compound

The fabric softening compound is preferably different from the TPTT material. Suitable fabric softening compounds are described below.

### (i) Oily Sugar Derivative

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The oily sugar derivatives of the invention are also referred to herein as “derivative-CP” and “derivative-R” dependent upon whether the derivative is a product derived from a cyclic polyol or from a reduced saccharide starting material respectively.

Preferably the derivative-CP and derivative-RS contain 35% by weight tri or higher esters, e.g. at least 40%.

Preferably 35 to 85% most preferably 40 to 80%, even more preferably 45 to 75%, such as 45 to 70% of the hydroxyl groups in said cyclic polyol or in said reduced saccharide are esterified or etherified to produce the derivative-CP and derivative-RS respectively.

For the derivative-CP and derivative-RS, the tetra, penta etc prefixes only indicate the average degrees of esterification or etherification. The compounds exist as a mixture of materials ranging from the monoester to the fully esterified ester. It is the average degree of esterification as determined by weight that is referred to herein.

The derivative-CP and derivative-RS used do not have substantial crystalline character at 20° C. Instead they are preferably in a liquid or soft solid state, as hereinbelow defined, at 20° C.

The starting cyclic polyol or reduced saccharide material is esterified or etherified with C₈-C₂₂ alkyl or alkenyl chains to the appropriate extent of esterication or etherification so that the derivatives are in the requisite liquid or soft solid state. These chains may contain unsaturation, branching or mixed chain lengths.

Typically the derivative-CP or derivative-RS has 3 or more, preferably 4 or more, for example 3 to 8, e.g. 3 to 5, ester or ether groups or mixtures thereof. It is preferred if two or more of the ester or ether groups of the derivative-CP and derivative-RS are independently of one another attached to a C₈ to C₂₂ alkyl or alkenyl chain. The alkyl or alkenyl groups may be branched or linear carbon chains.

The derivative-CPs are preferred for use as the oily sugar derivative. Inositol is a preferred cyclic polyol, and Inositol derivatives are especially preferred.

In the context of the present invention the terms derivative-CP and derivative-RS encompass all ether or ester derivatives of all forms of saccharides, which fall into the above definition, and are especially preferred for use. Examples of preferred saccharides for the derivative-CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the derivative-CP has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP and derivative-RS is typically between 1 and 3.

The derivative-CP and derivative-RS may have branched or linear alkyl or alkenyl chains (of varying degrees of branching), mixed chain lengths and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups, e.g. those attached may be derived from rape oil, cotton seed oil, soybean oil, oleic, tallow, palmitoleic, linoleic, erucic or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose trioleate, glucose tetraoleate, xylose trioleate, or sucrose tetra-, tri-, penta- or hexa-esters with any mixture of predominantly unsaturated fatty acid chains.

However some derivative-CPs and derivative-RSs may be based on alkyl or alkenyl chains derived from polyunsaturated fatty acid sources, e.g. sucrose tetralinoleate. It is preferred that most, if not all, of the polyunsaturation has been removed by partial hydrogenation if such polyunsaturated fatty acid chains are used.

The most highly preferred liquid derivative-CPs and derivative-RSs are any of those mentioned in the above three paragraphs but where the polyunsaturation has been removed through partial hydrogenation.

Especially good results are obtained when the alkyl and/or alkenyl chains of the derivative-CPs and derivative-RSs are obtained by using a fatty acid mixture (to react with the starting cyclic polyol or reduced saccharide) which comprises a mixture of tallow fatty acid and oleyl fatty acid in a weight ratio of 10:90 to 90:10, more preferably 25:75 to 75:25, most preferably 30:70 to 70:30. A fatty acid mixture comprising a mixture of tallow fatty acid and oleyl fatty acid in a weight ratio of 60:40 to 40:60 is most preferred.

Especially preferred are fatty acid mixtures comprising a weight ratio of approximately 50 wt % tallow chains and 50 wt % oleyl chains. It is especially preferred that the fatty acid mixture consists only of a mixture of tallow fatty acid and oleyl fatty acid.

Preferably 40% or more of the chains contain an unsaturated bond, more preferably 50% or more, most preferably 60% or more e.g. 65% to 95%.

Other oily sugar derivatives suitable for use in the compositions include sucrose pentalaurate, sucrose pentaerucate and sucrose tetraerucate. Suitable materials include some of the Ryoto series available from Mitsubishi Kagaku Foods Corporation.

The liquid or soft solid derivative-CPs and derivative-RSs are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CPE and derivative-RSE can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride, and, acylation of the cyclic polyol or of a reduced saccharide with a fatty acid. Typical preparations of these materials are disclosed in U.S. Pat. No. 4,386,213 and AU 14416/88 (Procter and Gamble).

When an oily sugar derivative is present the compositions preferably comprise between 0.5%-30% wt of the oily sugar derivatives, more preferably 1-20% wt, most preferably 1.5-20% wt, e.g. 3-15% wt %, based on the total weight of the composition.

### (ii) Cationic Fabric Softening Compounds

The preferred cationic fabric softening compound(s) are those having two or more alkyl or alkenyl chains each having an average chain length equal to, or greater than C₈, especially C₁₂₋₂₈ alkyl or alkenyl chains connected to a nitrogen atom. The alkyl or alkenyl groups are preferably connected via at least one ester link, more preferably via two or more ester linkages.

The cationic fabric softening compounds may be ester-linked quaternary ammonium fabric softening compounds or non-ester linked quaternary ammonium fabric softening compounds. The ester-linked quaternary ammonium fabric softening compounds are herein referred to as “the ester-softening compound”. The non-ester linked quaternary ammonium fabric softening compounds are herein referred to as “the non-ester softening compound”.

Especially suitable compounds have two or more alkyl or alkenyl chains each having an average chain length equal to, or greater than C₁₄, more preferably, equal to or greater C₁₆. Most preferably at least 50% of the total number of alkyl or alkenyl chains have a chain length equal to, or greater than C₁₈.

It is advantageous for environmental reasons if the ester-softening compound is biologically degradable. It is also preferred if the alkyl or alkenyl chains of the ester-softening compound are predominantly linear.

One preferred type of ester-softening compound is a quaternary ammonium material represented by formula (I):

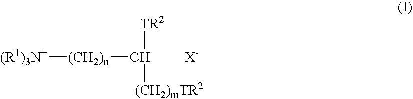

wherein T is

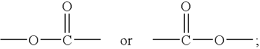

each R¹ group is independently selected from C₁₋₄, alkyl or hydroxyalkyl or C₂₋₄ alkenyl groups; and wherein each R² group is independently selected from C₈₋₂₈ alkyl or alkenyl groups, X⁻ is any suitable anion including a halide, acetate or lower alkosulphate ion, such as chloride or methosulphate, n is O or an integer from 1-5, and m is from 1-5.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy 3-trimethylammonium propane chloride.

A second preferred type of ester-softening compound is represented by the formula (II):

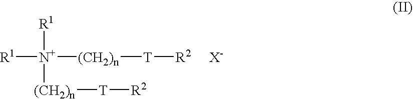

wherein T, R¹, R², n, and X⁻ are as defined above.

In this class di(tallowoyloxyethyl)dimethyl ammonium chloride and methyl bis-[ethyl(tallowoyl)]-2-hydroxyethyl ammonium methyl sulphate are especially preferred. The tallow chains in these compounds may be hardened and may even be fully unsaturated, i.e. preferred compounds also include di(hardened tallowoyloxy ethyl)dimethyl ammonium chloride and methyl bis-[ethyl(hardened tallowoyl)]-2-hydroxyethyl ammonium methyl sulphate. Commercially available compounds include those in the Tetranyl range (ex Kao) and Stepantex range (ex Stepan).

Also suitable are derivatives of the above formula where one or more of the (CH₂)ₙ chain(s) has at least one pendent alkyl chain e.g. a methyl chain. Examples include the cationic quaternary ammonium compounds described in WO 99/35223 and WO 99/35120 (Witco).

Another preferred softening active is triethanolamine di-alkylester methosulphate (TEAQ). The iodine value of the parent fatty acid is preferably in the range of from 20 to 60, more preferably from 25 to 50, still more preferably from 30 to 45, and most preferably from 30 to 42. Preferred mono-:di-:tri-ester distribution ratios of these materials are in the range as follows:—

Mono: from 28 to 42%, preferably 30 to 40%, most preferably 30 to 35%
Di: from 45 to 60%, preferably 50 to 55%
Tri: from 5 to 25%, preferably 5 to 15%, most preferably from 6 to 10%.

A third preferred type of ester-softening compound is a quaternary ammonium material represented by the formula (III):

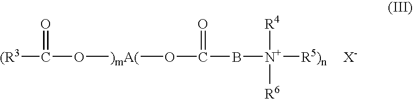

wherein X⁻ is as defined above, A is an (m+n) valent radical remaining after the removal of (m+n) hydroxy groups from an aliphatic polyol having p hydroxy groups and an atomic ratio of carbon to oxygen in the range of 1.0 to 3.0 and up to 2 groups per hydroxy group selected from ethylene oxide and propylene oxide, m is 0 or an integer from 1 to p-n, n is an integer from 1 to p-m, and p is an integer of at least 2, B is an alkylene or alkylidene group containing 1 to 4 carbon atoms, R³, R⁴, R⁵ and R⁶ are, independently from each other, straight or branched chain C₁-C₄₈ alkyl or alkenyl groups, optionally with substitution by one or more functional groups and/or interruption by at most 10 ethylene oxide and/or propylene oxide groups, or by at most two functional groups selected from;

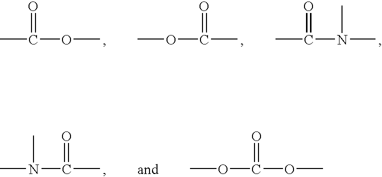

or R⁴ and R⁵ may form a ring system containing 5 or 6 atoms in the ring, with the proviso that the average compound either has at least one R group having 22-48 carbon atoms, or at least two R groups having 16-20 carbon atoms, or at least three R groups having 10-14 carbon atoms. Preferred compounds of this type are described in EP 638 639 (Akzo).

The non-ester softening compound preferably has the alkyl or alkenyl chain lengths referred to above (in respect of the non-ester softening compounds).

One preferred type of non-ester softening compound is a quaternary ammonium material represented by formula (IV):

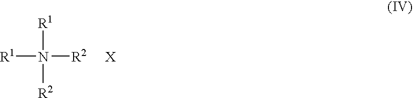

wherein each R¹ group is independently selected from C₁₋₄ alkyl, hydroxyalkyl or C₂₋₄ alkenyl groups; each R group is independently selected from C₈₋₂₈ alkyl or alkenyl groups, and X⁻ is as defined above.

A preferred material of formula (IV) is di-hardened tallow-dimethyl ammonium chloride, sold under the Trademark ARQUAD 2HT by Akzo Nobel.

The compositions preferably comprise a total amount of between 0.5% wt-30% by weight of the cationic fabric softening compounds, preferably 1%-25%, more preferably 1.5-22%, most preferably 2%-20%, based on the total weight of the composition.

### Non-Ionic Surfactant

A non-ionic surfactant may be present in order to stabilise the composition, or perform other functions such as emulsifying any oil that may be present.

Suitable non-ionic surfactants include alkoxylated materials, particularly addition products of ethylene oxide and/or propylene oxide with fatty alcohols, fatty acids and fatty amines.

Preferred materials are of the general formula:

R—Y—(CH₂CH₂O)H

Where R is a hydrophobic moiety, typically being an alkyl or alkenyl group, said group being linear or branched, primary or secondary, and preferably having from 8 to 25, more preferably 10 to 20, and most preferably 10 to 18 carbon atoms; R may also be an aromatic group, such as a phenolic group, substituted by an alkyl or alkenyl group as described above; Y is a linking group, typically being O, CO.O, or CO.N(R¹), where R¹ is H or a C₁₋₄ alkyl group; and z represents the average number of ethoxylate (EO) units present, said number being 8 or more, preferably 10 or more, more preferably 10 to 30, most preferably 12 to 25, e.g. 12 to 20.

Examples of suitable non-ionic surfactants include the ethoxylates of mixed natural or synthetic alcohols in the “coco” or “tallow” chain length. Preferred materials are condensation products of coconut fatty alcohol with 15-20 moles of ethylene oxide and condensation products of tallow fatty alcohol with 10-20 moles of ethylene oxide.

The ethoxylates of secondary alcohols such as 3-hexadecanol, 2-octadecanol, 4-eicosanol, and 5-eicosanol may also be used. Exemplary ethoxylated secondary alcohols have formulae C₁₂-EO(20); C₁₄-EO(20); C₁₄-EO(25); and C₁₆-EO(30). Especially preferred secondary alcohols are disclosed in PCT/EP2004/003992 and include Tergitol-15-S-3.

Polyol-based non-ionic surfactants may also be used, examples including sucrose esters (such as sucrose monooleate), alkyl polyglucosides (such as stearyl monoglucoside and stearyl triglucoside), and alkyl polyglycerols.

### Fatty Complexing Agent

A preferred additional component in the compositions of the present invention is a fatty complexing agent. Such agents typically have a C₈ to C₂₂ hydrocarbyl chain present as part of their molecular structure. Suitable fatty complexing agents include C₈ to C₂₂ fatty alcohols and C₈ to C₂₂ fatty acids; of these, the C₈ to C₂₂ fatty alcohols are most preferred. A fatty complexing agent is particularly valuable in compositions comprising a QAC having a single C₁₂₋₂₈ group connected to the nitrogen head group, such as mono-ester associated with a TEA ester quat. or a softening agent of formula II, for reasons of product stability and effectiveness.

Preferred fatty acid complexing agents include hardened tallow fatty acid (available as Pristerene, ex Uniqema).

Preferred fatty alcohol complexing agents include C₁₆/C₁₈ fatty alcohols (available as Stenol and Hydrenol, ex Cognis, and Laurex CS, ex Albright and Wilson) and behenyl alcohol, a C₂₂ fatty alcohol, available as Lanette 22, ex Henkel.

The fatty complexing agent may be used at from 0.1% to 10%, particularly at from 0.2% to 5%, and especially at from 0.4 to 2% by weight, based on the total weight of the composition.

### Perfume

The compositions of the invention typically comprise one or more perfumes. The perfume is preferably present in an amount from 0.01 to 10% by weight, more preferably 0.05 to 5% by weight, most preferably 0.5 to 4.0% by weight, based on the total weight of the composition.

### Viscosity Modifiers

The Fabric softening compositions may comprise viscosity modifiers. Suitable viscosity modifiers are disclosed, for example, in WO 02/081611, US 2004/0214736, U.S. Pat. No. 6,827,795, EP 0501714, US 2003/0104964, EP 0385749 and EP 331237.

### Further Optional Ingredients

The compositions of the invention may contain one or more other ingredients. Such ingredients include preservatives (e.g. bactericides), pH buffering agents, perfume carriers, fluorescers, colourants, hydrotropes, antifoaming agents, anti-redeposition agents, soil-release agents, electrolytes including polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids and dyes.

### Product Use

The compositions of the present invention are preferably rinse conditioner compositions and may be used in the rinse cycle of a domestic laundry process.

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry.

### Preparation

Compositions used in the invention can be prepared by any method suitable for preparing dispersed, emulsified systems. One method involves the forming of a molten premixture of the active materials in water at an elevated temperature, adding additional water to obtain the desired active concentration, and then cooling to ambient temperature. When desired, some minor ingredients such as electrolytes, colouring agents, etc. may be post-dosed. A second method involves the forming of the product by phase inversion of a water in hydrocarbon emulsion, wherein the cationic material is either part of the hydrocarbon phase or added as a separate predispersion. This method is advantageous, because this provides very finely divided hydrocarbon particles in the final product. In an alternative method the encapsulated TPTT material may be post dosed in the form of an aqueous slurry.

The invention will be illustrated by the following Examples.

### Apparatus

### (1) AOIP Thermal Finger for Sensory Analysis

The thermal finger used for sensory analysis was supplied by AOIP SAS, Zac de l'Orme Pomponne, 91130 Ris Orangis, France.

### Preliminary Specifications

Measurement process: The thermal finger is set to human finger temperature by placing it into a micro oven. When temperature is stable it is indicated by a sound beep. At this moment, the “thermal finger” can be put on surface to measure.

Evaluation method:
For insulating materials, the drop of temperature after around 100 sec is used to determine the sensorial note (by integrating calculation using polynomial regression).
For conductive materials, displayed value corresponds to the slope value after 3 seconds; this time is adjustable. Display: The 2 sensorial evaluation notes are displayed on the alphanumerical screen.

Range: 0 to 100 for evaluation after 100 s and after 3 s for slope.

Finger dimensions: diameter 30 mm; extremity made of natural rubber, 6 mm thick.

Position of temperature measurement: 0.8 mm under free surface of rubber.

Finger temperature: adjustable from 20° C. to 40° C.+/−0.2° C.

Environmental temperature: Displayed value from 0° C. to 49° C.±0.2° C.

Number of measurements in 100 s:5000

### (2) Pad Mangles

Vertical laboratory padder VFM type ex. Werner Mathis AG

### Materials

Fabric: 100% cotton (jersey knit (175 gm⁻²).

Lurapet TX PMC 28 is an encapsulated TPTT material commercially available from BASF.
Stepantex UL 85 Cationic Fabric Softener commercially available from Stepan.
Genapol C200 is cocoalcohol 20EO commercially available from Clariant.
Stenol 1618 is tallow alcohol commercially available from Cognis.

### EXAMPLE

The following compositions were prepared:

| | % by Weight |
|---|---|
| Composition A | |
| Lurapret TX PCM 28 | 20.00 |
| Cationic Fabric Softener (Stepantex UL 85) | 10.14 |
| Nonionic (Genapol C200) | 0.30 |
| Tallow alcohol (Stenol 1618) | 0.80 |
| Perfume | 0.74 |
| Water | 68.02 |
| Composition B | |
| Lurapret TX PMC 28 | 50.00 |
| Cationic Fabric Softener | 6.34 |
| Nonionic | 0.19 |
| Tallow alcohol | 0.50 |
| Perfume | 0.47 |
| Water | 42.50 |
| Composition C | |
| (European Comfort Concentrate) | |
| Cationic Fabric Softener | 12.76 |
| Nonionic | 0.38 |
| Tallow alcohol | 1.0 |
| Perfume | 0.93 |
| Water | 85.09 |
| Composition D | |
| Lurapret TX PMC 28 | 10.00 |
| Water | 90.00 |

### Procedure

### Treatment

Samples of clean cotton were cut into 15 cm×10 cm pieces Fabric samples were treated with prototypes using a pad mangle.

Composition A was diluted to make a 10% w/w dispersion for pad application. This 10% dispersion was pad applied to the knitted cotton at 100% pick-up which evenly delivered 2% o.w.f. (on weight of fabric) of the encapsulated phase change material (Lurapret TX PMC 28) and 1% o.w.f. of standard rinse conditioner active to the fabric.

Composition B was diluted to make a 44% w/w dispersion for further dilution. This 44% dispersion was diluted to make 1.38% w/w dispersion for pad application. The 1.38 w/w dispersion was pad applied to the knitted cotton at 100% pick-up which evenly delivered 0.7% o.w.f. of the encapsulated phase change material (Lurapret TX PMC 28) and 0.087% o.w.f. of standard rinse conditioner active to the fabric.

Composition C was diluted to make a 1.38% w/w dispersion for pad application. This 1.38% dispersion was pad applied to the knitted cotton at 100% pick-up which evenly delivered 0.175% o.w.f. of standard rinse conditioner active to the fabric.

Composition D is a 10% dispersion which was pad applied to the knitted cotton at 100% pick-up and evenly delivered 10% o.w.f. of the encapsulated phase change material (Lurapret TX PMC 28) to the fabric

The treated fabric samples were allowed to dry in air.

### Measurement

The treated dried samples were then measured using the AOIP

Thermal finger for sensory analysis.

Measurements were made in a temperature & humidity controlled room (21° C. & 50% RH).

The measurement involves the following:
Pre-heating of the thermal finger to 37° C. in a micro oven.
Remove the thermal finger from the oven and place the sensor on the surface of the test substrate with a force governed by a 500 g mass placed on top of the finger apparatus.
The thermal finger takes temperature measurements for 100 seconds.
The thermal finger is then replaced in the micro oven to reheat for the next measurement.
Note down the measurements made (Room temperature, Start temperature, Slope, Mark & dTemp).

### Results

The results are shown in the accompanying drawing as Mark against treatment.

Mark—the cool feel parameter derived from the correlation between the score (parameter given by expert panellists from AIOP give to initial surface temperature) and the thermal conductive measurements made by the thermal finger. The lower figures represent a colder sensation.

1. A fabric softening composition comprising a fabric softening compound and a material having a thermal phase transition temperature in the range 26 to 39° C. encapsulated in a polymer shell (TPTT material) to provide encapsulated particles having a particle size in the ranges from 10 nm to 1000 μm, preferably from 50 nm to 100 μm, more preferably 0.2 to 20 μm.

2. A composition as claimed in claim 1 in which the TPTT material comprises a hydrocarbon or mixture of hydrocarbons.

3. A composition as claimed in claim 1 in which the TPTT material is present in an amount from 5 to 50%, preferably 5 to 25% by weight of the composition.

4. A composition as claimed in claim 1 in which the fabric conditioning composition is selected from an oily sugar derivative, a cationic fabric softening compound and mixture thereof.

5. A composition as claimed in claim 4 in which the cationic fabric softening compound is a quaternary ammonium compound having at least two C₁₂₋₂₈ groups connected to the nitrogen head group that may independently be alkyl or alkenyl groups, preferably being connected to the nitrogen head group by an ester link.

6. A composition as claimed in claim 1 which additionally comprises one or more ingredients selected from perfume, non-ionic surfactant, fatty acid, fatty alcohol and viscosity modifier.

7. The use of a fabric softening composition comprising a fabric softening compound and a material having a thermal phase transition temperature in the range 26 to 39° C. to impart a cool feel to a fabric.

8. The use as claimed in claim 7 in which the fabric softening composition is as defined in any one of the claims 1 to 6.

9. The use as claimed in claim 7 in which the fabric softening composition deposits from 0.2 to 1%, preferably from 0.2 to 0.5% by weight based on the fabric of said TPTT material.

10. The use as claimed in claim 8 in which the fabric softening composition deposits from 0.2 to 1%, preferably from 0.2 to 0.5% by weight based on the fabric of said TPTT material.
